(19) United States
(12) Patent Application Publication
(10) Pub. No.: US 2023/0206456 A1
(43) Pub. Date: Jun. 29, 2023

(54) SYSTEM AND METHOD FOR POINT SUPERVISED EDGE DETECTION

(71) Applicant: GM CRUISE HOLDINGS LLC, SAN FRANCISCO, CA (US)

(72) Inventors: Jong Yae Lee, Walnut Creek, CA (US); Xueyan Zou, Madison, WI (US); Haotian Liu, Madison, WI (US)

(73) Assignee: GM CRUISE HOLDINGS LLC, SAN FRANCISCO, CA (US)

(21) Appl. No.: 17/560,679

(22) Filed: Dec. 23, 2021

(51) Int. Cl. G06T 7/13; G06T 9/00

(52) U.S. Cl. CPC G06T 7/13; G06T 9/007

(57) ABSTRACT

For one embodiment of the present invention, a method of object instance edge detection and segmentation is described. The method includes obtaining an input image with a shape and extracting, with a feature extractor of a point supervised transformer model, a hierarchical combination of features from the input image including a set of feature maps having different levels. The method further includes receiving, with a transformer decoder, an output including a feature map from the feature extractor, and object queries each with d dimensions, training the point supervised transformer model with a sparse set of keypoint annotations along a boundary of each object instance, and generating a box prediction, a classification prediction, and a coefficient prediction for each object instance based on an output from the transformer decoder.

### TECHNICAL FIELD

Embodiments described herein generally relate to the fields of data processing and machine learning, and more particularly relates to a system and method for point supervised edge detection.

### BACKGROUND

Edge detection has long been an important problem in the field of computer vision. Previous approaches have explored category-agnostic or category-aware edge detection. Detecting clear boundaries of object instances is important for many tasks including autonomous driving and robotics applications. However, obtaining high-quality edge annotations is computationally expensive.

### SUMMARY

For one embodiment of the present invention, a method of object instance edge detection and segmentation is described. The method includes obtaining an input image with a shape and extracting, with a feature extractor of the point supervised transformer model, a hierarchical combination of features from the input image in the form of a set of feature maps having different levels. The method further includes receiving, with a transformer decoder, an output including a feature map from the feature extractor, and n input object queries each with d dimensions, training the point supervised transformer model with a sparse set of keypoint annotations along a boundary of each object instance, and generating, with a prediction head, a box prediction, a classification prediction, and a coefficient prediction for each object instance based on an output from the transformer decoder.

Other features and advantages of embodiments of the present invention will be apparent from the accompanying drawings and from the detailed description that follows below.

### BRIEF DESCRIPTION OF THE DRAWINGS

FIG. 1 illustrates an autonomous vehicle and remote computing system architecture in accordance with one embodiment.

FIG. 2A illustrates a ground truth image.

FIG. 2B illustrates object boundaries for a BMask Rcnn object detection model.

FIG. 2C illustrates object boundaries for a Mask Rcnn object detection model.

FIG. 2D illustrates object boundaries for a DETR mask model in accordance with one embodiment.

FIG. 2E illustrates object boundaries for a DETR point supervised model in accordance with one embodiment.

FIG. 3A illustrates an object boundary of a model that due to the sparsity of keypoints, simply connects adjacent keypoints to ‘complete the edge’ and this can often lead to incorrect annotations.

FIG. 3B illustrates an image generated based on cross attention weights between object queries and image feature in DETR in accordance with one embodiment.

FIGS. 4A and 4B illustrate a computer-implemented method for point supervised edge detection in accordance with one embodiment.

FIG. 5 illustrates a point supervised transformer model 500 for instance edge detection in accordance with one embodiment.

FIGS. 6A and 6B illustrate a point supervised transformer model 600 for instance edge detection in accordance with one embodiment.

FIG. 6C illustrates operations of a FPN in accordance with one embodiment.

FIG. 6D illustrates operations of a coefficient head and a matrix multiplier in accordance with one embodiment.

FIG. 7 illustrates a boundary having different ratios of keypoints in accordance with one embodiment.

FIG. 8A illustrates how bipartite matching is used to match the predicted edges PD with the ground-truth edges GT in accordance with one embodiment.

FIG. 8B illustrates boundary annotations of a model being evaluated on MS COCO and as well as LVIS in accordance with one embodiment.

FIG. 9 illustrates qualitative results for a ground truth, a BMask Rcnn model, and a Mask Rcnn model.

FIG. 10 illustrates qualitative results for a DETR mask model and a DETR point model in accordance with one embodiment.

FIG. 11 illustrates a diagram of a computer system including a data processing system according to an embodiment of the invention.

### DETAILED DESCRIPTION OF EMBODIMENTS

A system and method for point supervised instance detection and segmentation are described. An efficient point supervised instance edge detection method uses a sparse set of annotated points as supervision. A novel transformer architecture provides a feature extractor, transformer decoder, and a dense prediction head. This novel transformer architecture achieves accurate edge detection results at a fraction of the full annotation cost due to using the sparse set of annotated points as supervision. The point supervised instance edge detection method demonstrates highly competitive instance edge detection performance with respect to the state-of-the-art, and also shows that the proposed task and loss are complementary to instance segmentation.

In the following description, for purposes of explanation, numerous specific details are set forth in order to provide a thorough understanding of the present invention. It will be apparent, however, to one skilled in the art that the present invention can be practiced without these specific details. In other instances, well-known structures and devices are shown in block diagram form in order to avoid obscuring the present invention.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

The point supervised instance edge detection method of the present disclosure addresses the problem of instance edge detection. Unlike category-agnostic or category-aware (semantic) edge detection, instance edge detection requires predicting the semantic edge boundaries of each object instance. This problem is fundamental and can be of great importance to a variety of computer vision tasks including segmentation, detection/recognition, tracking and motion analysis, and 3D reconstruction. In particular, instance edge detection can be important for applications that require precise object localization such as autonomous driving or robot grasping.

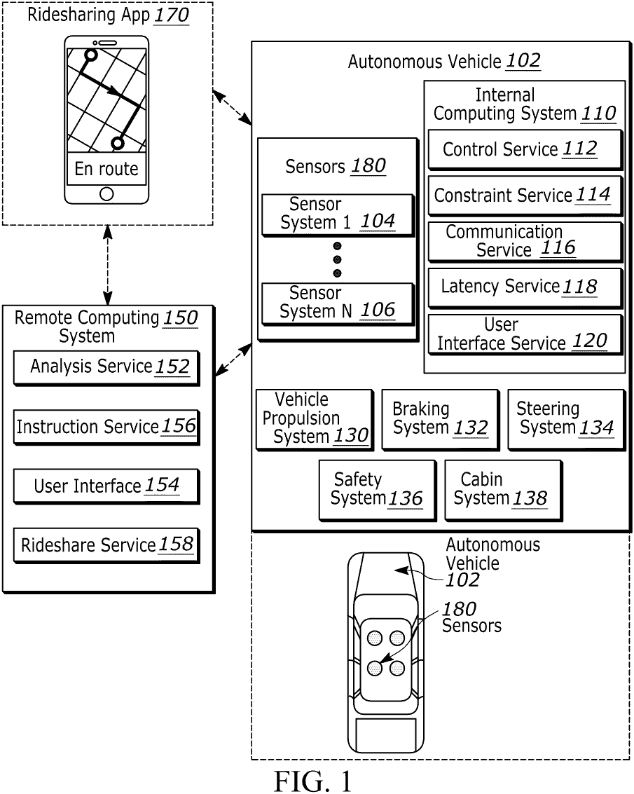

FIG. 1 illustrates an autonomous vehicle and remote computing system architecture in accordance with one embodiment. The autonomous vehicle 102 can navigate about roadways without a human driver based upon sensor signals output by sensor systems 180 of the autonomous vehicle 102. The autonomous vehicle 102 includes a plurality of sensor systems 180 (a first sensor system 104 through an Nth sensor system 106). The sensor systems 180 are of different types and are arranged about the autonomous vehicle 102. For example, the first sensor system 104 may be a camera sensor system and the Nth sensor system 106 may be a Light Detection and Ranging (LIDAR) sensor system. Other exemplary sensor systems include radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems such as Global Positioning System (GPS) receiver systems, accelerometers, gyroscopes, inertial measurement units (IMU), infrared sensor systems, laser rangefinder systems, ultrasonic sensor systems, infrasonic sensor systems, microphones, or a combination thereof. While four sensors 180 are illustrated coupled to the autonomous vehicle 102, it should be understood that more or fewer sensors may be coupled to the autonomous vehicle 102.

The autonomous vehicle 102 further includes several mechanical systems that are used to effectuate appropriate motion of the autonomous vehicle 102. For instance, the mechanical systems can include but are not limited to, a vehicle propulsion system 130, a braking system 132, and a steering system 134. The vehicle propulsion system 130 may include an electric motor, an internal combustion engine, or both. The braking system 132 can include an engine brake, brake pads, actuators, and/or any other suitable componentry that is configured to assist in decelerating the autonomous vehicle 102. In some cases, the braking system 132 may charge a battery of the vehicle through regenerative braking. The steering system 134 includes suitable componentry that is configured to control the direction of movement of the autonomous vehicle 102 during navigation.

The autonomous vehicle 102 further includes a safety system 136 that can include various lights and signal indicators, parking brake, airbags, etc. The autonomous vehicle 102 further includes a cabin system 138 that can include cabin temperature control systems, in-cabin entertainment systems, etc.

The autonomous vehicle 102 additionally comprises an internal computing system 110 that is in communication with the sensor systems 180 and the systems 130, 132, 134, 136, and 138. The internal computing system includes at least one processor and at least one memory having computer-executable instructions that are executed by the processor. The computer-executable instructions can make up one or more services responsible for controlling the autonomous vehicle 102, communicating with remote computing system 150, receiving inputs from passengers or human co-pilots, logging metrics regarding data collected by sensor systems 180 and human co-pilots, etc.

The internal computing system 110 can include a control service 112 that is configured to control operation of the vehicle propulsion system 130, the braking system 208, the steering system 134, the safety system 136, and the cabin system 138. The control service 112 receives sensor signals from the sensor systems 180 as well communicates with other services of the internal computing system 110 to effectuate operation of the autonomous vehicle 102. In some embodiments, control service 112 may carry out operations in concert one or more other systems of autonomous vehicle 102.

The internal computing system 110 can also include a constraint service 114 to facilitate safe propulsion of the autonomous vehicle 102. The constraint service 116 includes instructions for activating a constraint based on a rule-based restriction upon operation of the autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of the control service 112.

The internal computing system 110 can also include a communication service 116. The communication service can include both software and hardware elements for transmitting and receiving signals from/to the remote computing system 150. The communication service 116 is configured to transmit information wirelessly over a network, for example, through an antenna array that provides personal cellular (long-term evolution (LTE), 3G, 4G, 5G, etc.) communication.

In some embodiments, one or more services of the internal computing system 110 are configured to send and receive communications to remote computing system 150 for such reasons as reporting data for training and evaluating machine learning algorithms (e.g., training and evaluating of point supervised transformer model for instance edge detection and instance segmentation), requesting assistance from remoting computing system or a human operator via remote computing system 150, software service updates, ridesharing pickup and drop off instructions etc.

The internal computing system 110 can also include a latency service 118. The latency service 118 can utilize timestamps on communications to and from the remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, the latency service 118 can enable other systems of autonomous vehicle 102 or a passenger to make necessary decisions or to provide the needed feedback.

The internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 140 regarding reporting data for training and evaluating machine learning algorithms (e.g., training and evaluating of point supervised transformer model for instance edge detection and instance segmentation), requesting assistance from remote computing system 150 or a human operator via the remote computing system 150, software service updates, rideshare pickup and drop off instructions, etc.

The remote computing system 150 includes an analysis service 152 that is configured to receive data from autonomous vehicle 102 and analyze the data to train or evaluate machine learning algorithms for operating the autonomous vehicle 102 such as performing object detection for methods and systems (e.g., system 400) disclosed herein. The analysis service 152 can also perform analysis pertaining to data associated with one or more errors or constraints reported by autonomous vehicle 102. In another example, the analysis service 152 is located within the internal computing system 110.

The remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

The remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

The remote computing system 150 can also include a rideshare service 158 configured to interact with ridesharing applications 170 operating on (potential) passenger computing devices. The rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle to 102 go around an obstacle, change routes, honk the horn, etc.

The rideshare service 158 as depicted in FIG. 1 illustrates a vehicle 102 as a triangle en route from a start point of a trip to an end point of a trip, both of which are illustrated as circular endpoints of a thick line representing a route traveled by the vehicle. The route may be the path of the vehicle from picking up the passenger to dropping off the passenger (or another passenger in the vehicle), or it may be the path of the vehicle from its current location to picking up another passenger.

As previously mentioned, previous approaches for object detection have explored category-agnostic or category-aware edge detection. Also, an instance edge detection approach adds an edge detection head to the Mask R-CNN framework. Although achieving strong performance, this approach inherits all of Mask R-CNN′s hand-designed components like anchors and non-max suppression (NMS). Meanwhile, a recent detection transformer (DETR) object detector has drawn significant attention as it greatly simplifies the detection pipeline by achieving end-to-end learning without the region of interest (ROI) pooling, NMS, and anchor modules.

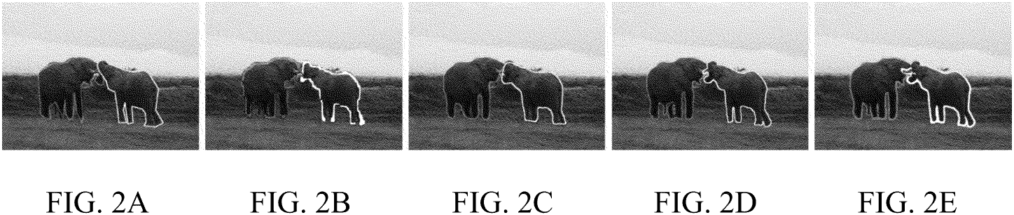

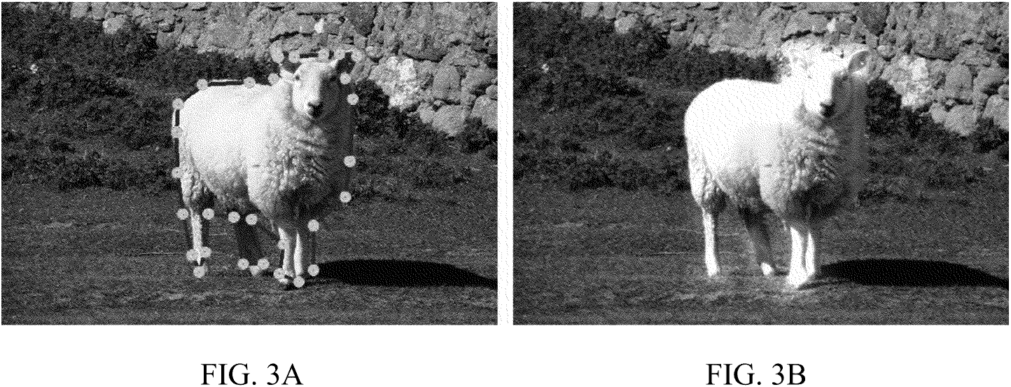

Several transformer based object detection models have shown that object boundaries produce high responses in the attention maps as illustrated in the FIG. 2D DETR mask and FIG. 2E DETR point of the present disclosure compared to other approaches such as BMask Rcnn in FIG. 2B and Mask Rcnn in FIG. 2C. FIG. 2A illustrates a ground truth image. Ground truth is information that is known to be real or true, provided by direct observation and measurement as opposed to information provided by inference. FIGS. 2D and 2E suggest that transformer based architectures are very suitable for instance edge detection.

A novel instance edge detector based on the DETR object detector framework is selected to address the problem of instance edge detection. Instance level recognition is a visual recognition task to recognize a specific instance of an object (e.g., specific type of automobile) not just object class (e.g., automobile object class). Also, a light weight edge detection head is added that computes the similarity between object queries and each feature pixel, and a feature pyramid structure is provided to obtain high-resolution feature maps which are important for precise pixel-level edge detection. To generate the output edge map for each object query, the instance edge detector linearly combines the high-resolution feature maps weighted by the corresponding predicted edge coefficients (i.e., the feature maps are shared for all queries).

One key challenge with instance edge detection is an annotation requirement - labeling all pixels along an object instance’s contour, which can be extremely costly in terms of time and computational resources. Thus, the instance edge detector of the present disclosure is trained using only a sparse set of keypoint annotations along the object instance’s boundary.

For instance segmentation, this results in a 4.7x speed up over annotating all points. However, due to the sparsity, simply connecting adjacent keypoints to ‘complete the edge’ can often lead to incorrect annotations, as shown in FIG. 3A. Although the annotated points are mostly correct, the edges that connect the annotated points do not align well to the object’s boundary.

FIG. 3B illustrates an image generated based on cross attention weights between object queries and image feature in accordance with one embodiment. The edge detector of the present disclosure is trained using only the keypoints, and a novel training loss is designed to account for the sparse keypoint annotation. Additionally, as instance edge detection and instance segmentation are closely related, training the model to solve both tasks leads to complementary benefits on instance segmentation without any additional supervision since both tasks are trained using the same set of keypoints. In this way, each object query in the point supervised transformer model can be thought of as simultaneously containing category, bounding box, instance segmentation, and instance edge information.

The novel point supervised transformer model for instance edge detection of the present disclosure achieves highly competitive results on the COCO and LVIS datasets compared to related state-of-the-art baselines. This point supervised transformer model can easily be extended to simultaneously perform instance edge detection and segmentation, and shows complementary benefits. Ablation studies are also performed to highlight design choices.

The present disclosure provides edge detection in the semantic and instance aware setting to localize object instance boundaries.

Instance segmentation is closely related to instance edge detection. After all, in theory, an instance’s boundary can be trivially extracted from the output of any standard instance segmentation algorithm. However, in practice, this naive solution does not produce good results. Since an instance segmentation algorithm is trained to correctly predict all pixels that belong to an object, and since there are relatively few pixels on an instance’s contour than inside of it, the model has no strong incentive to accurately localize the instance boundaries.

The transformer has become the state-of-the-art architecture for natural language processing tasks. However, despite its high accuracy, the transformer architecture suffers from slow convergence and quadratic computation and memory consumption necessitating a high number of GPUs and up to weeks for training. Recently, the transformer has begun to be explored for visual recognition tasks including image classification, detection, image generation, etc. Since image data typically has longer input sequences (pixels) than text data, the computation and memory problem is arguably more critical in this setting. To address this, researchers have proposed methods that reduce both computation and memory complexity, allowing the transformer to perform dense prediction tasks. In computer vision, pixelwise dense prediction is the task of predicting a label for each pixel in the image. Apart from the efficiency problem, the vision transformer also suffers from long training times especially for object detection. The point supervised transformer model of the present disclosure provides a DETR framework for instance edge detection and segmentation.

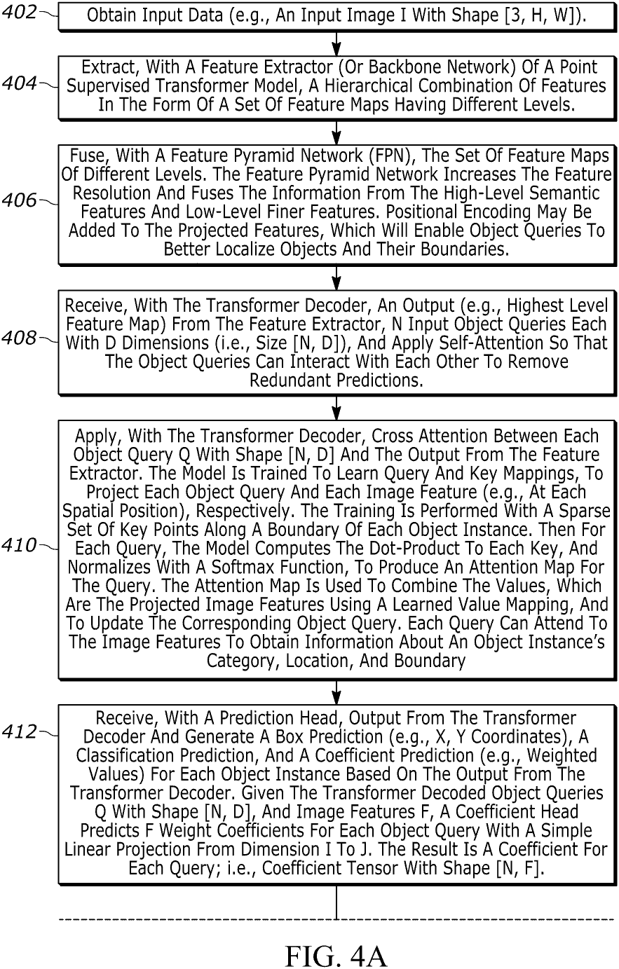

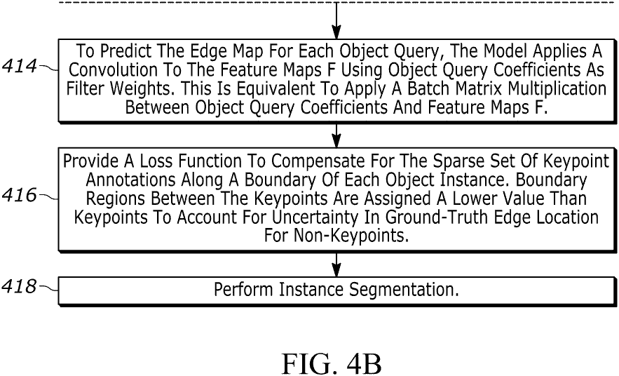

FIGS. 4A and 4B illustrate a computer-implemented method for point supervised edge detection in accordance with one embodiment. This computer-implemented method can be performed by processing logic of a data processing system that may comprise hardware (circuitry, dedicated logic, a processor, etc.), software (e.g., software that is run on a general purpose computer system or a dedicated machine or a device, software components of point supervised transformer model), or a combination of both. In one example, the method can be performed by an internal or remoting computing system of FIG. 1 or the computer system 1200.

The point supervised edge detection of a point supervised transformer model is performed without training with dense pixel-level labels, and instead with only box supervision. The model is trained with a sparse set of keypoint annotations along a boundary of each object instance and without labeling all pixels along a boundary of each object instance.

At operation 402, the computer-implemented method obtains input data (e.g., an input image I with shape [3, h, w]). The input image can be obtained from various sources and may be obtained from one or more sensors. In one example, the sensors may be coupled to a vehicle. Given an input image I, the task of instance edge detection is to correctly predict the boundaries of each object instance together with its category label with multiple object instances within each object of an image.

At operation 404, a feature extractor (or backbone network) of a point supervised transformer model extracts a hierarchical combination of features in the form of a set of feature maps having different levels. In one example, the feature extractor is a residual network together with a transformer encoder with self-attention. The backbone network is used as a feature extractor to provide a feature map representation of an input.

At operation 406, a feature pyramid network (FPN) fuses the feature maps of different levels. The feature pyramid network increases the feature resolution and fuses the information from the high-level semantic features and low-level finer features. Positional encoding may be added to the projected features, which will enable object queries to better localize objects and their boundaries. In each layer of the FPN, the previous layer’s lower resolution feature map is upsampled and fused together with the corresponding higher resolution feature map from the feature extractor.

In one example, a transformer decoder is connected with the highest level feature map and a light weight dense prediction head can perform instance edge detection along with classification and box localization.

At operation 408, the transformer decoder receives an output (e.g., highest level feature map) from the feature extractor, n input object queries each with d dimensions (i.e., size [n, d]), and applies self-attention so that the object queries can interact with each other to remove redundant predictions. At operation 410, the transformer decoder then applies cross attention between each object query Q with shape [n, d] and the output from the feature extractor. The model is trained to learn query and key mappings, to project each object query and each image feature (e.g., at each spatial position), respectively. The training is performed with a sparse set of keypoints along a boundary of each object instance. Then for each query, the model computes the dot-product to each key, and normalizes with a softmax function, to produce an attention map for the query. The attention map is used to combine the values, which are the projected image features using a learned value mapping, and to update the corresponding object query. Each query can attend to the image features to obtain information about an object instance’s category, location, and boundary

At operation 412, a dense prediction head receives output from the transformer decoder and generates a box prediction (e.g., x, y coordinates), a classification prediction to classify an object or each object instance, and a coefficient prediction (e.g., weighted values) for each object instance based on the output from the transformer decoder. Given the transformer decoded object queries Q with shape [n, d], and image features F, a coefficient head predicts f weight coefficients for each object query with a simple linear projection from dimension i to j. The result is a coefficient for each query; i.e., coefficient tensor with shape [n, f].

Then, at operation 414, to predict the edge map for each object query, the model applies a convolution to the feature maps F using object query coefficients as filter weights. This is equivalent to apply a batch matrix multiplication between object query coefficients and feature maps F. This dense prediction head is general and very light weight, and is applicable to any object instance based pixel classification task. Pixelwise dense prediction is the task of predicting a label for each pixel in the image.

At operation 416, the model provides a loss function to compensate for the sparse set of keypoint annotations along a boundary of each object instance. Boundary regions between the keypoints are assigned a lower value than the original keypoints to account for uncertainty in ground-truth edge location for non-keypoints.

At operation 418, the model can perform instance segmentation. The instance edge detection and instance segmentation can be performed simultaneously.

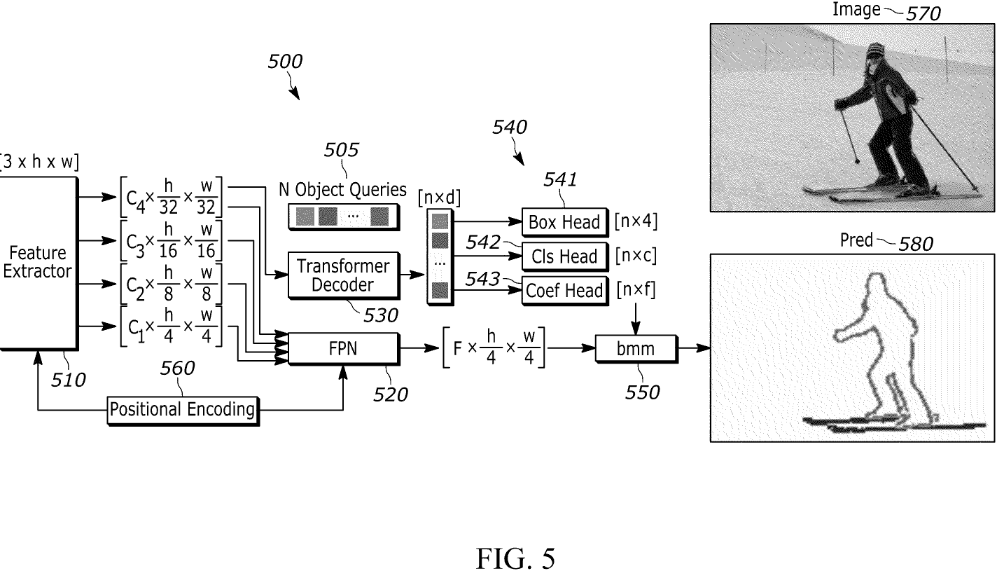

FIG. 5 illustrates a point supervised transformer model 500 for instance edge detection in accordance with one embodiment. The point supervised transformer model includes primarily a feature extractor 510, feature pyramid network (FPN) 520, transformer decoder 530, a prediction head 540, and a batch matrix multiplier (bmm) component 550 that performs batch matrix multiplication. An output dimension for each component is indicated in [∗].

Given an input image I, the task of instance edge detection is to correctly predict the boundaries of each object instance GE = {e0, e1, ..., en} together with its category label GC = {10,11, ..., 1n}, where n is the number of instances within an image.

A feature extractor 510 (or backbone network 510) extracts a hierarchical combination of features, a feature pyramid network 520 fuses the feature maps of different levels, a transformer decoder 530 receives a highest level feature map from the feature extractor 510, a light weight dense prediction head 540 can perform instance edge detection along with classification and box localization. Loss functions are introduced below to evaluate point based instance edge detection.

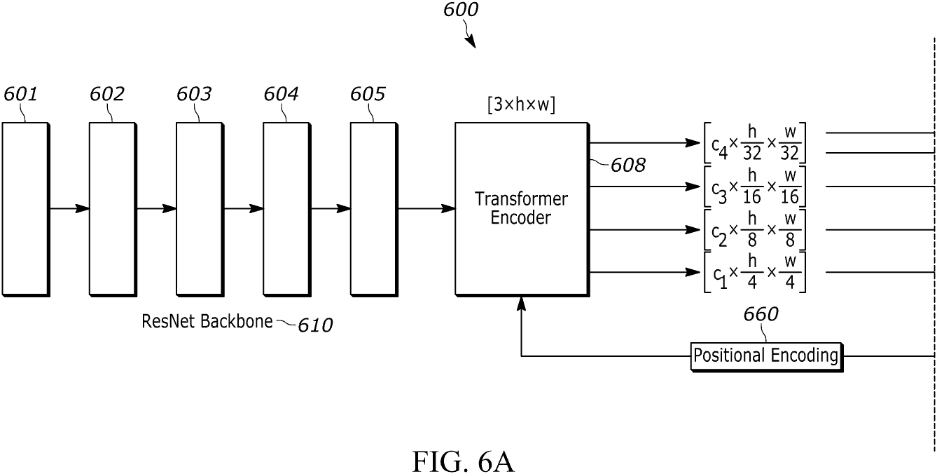

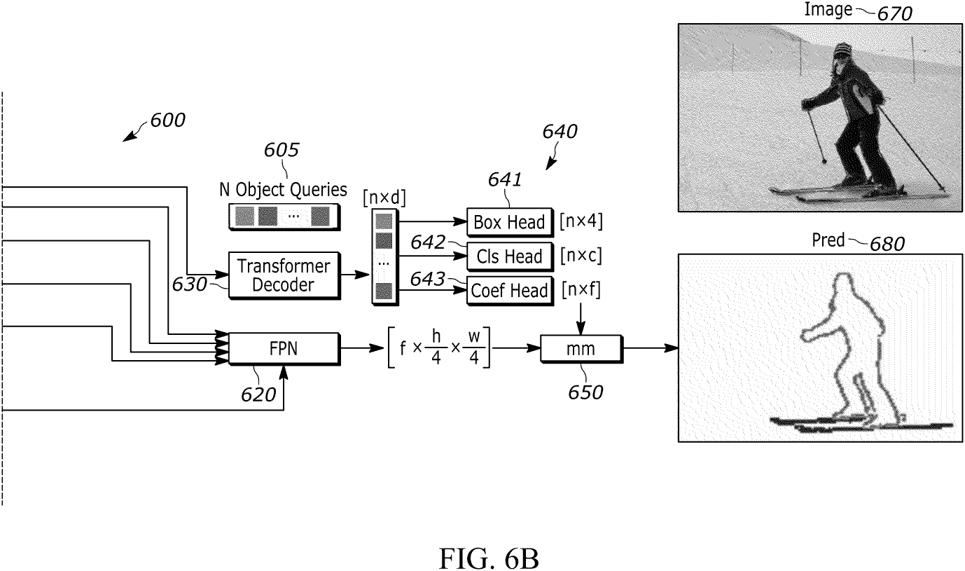

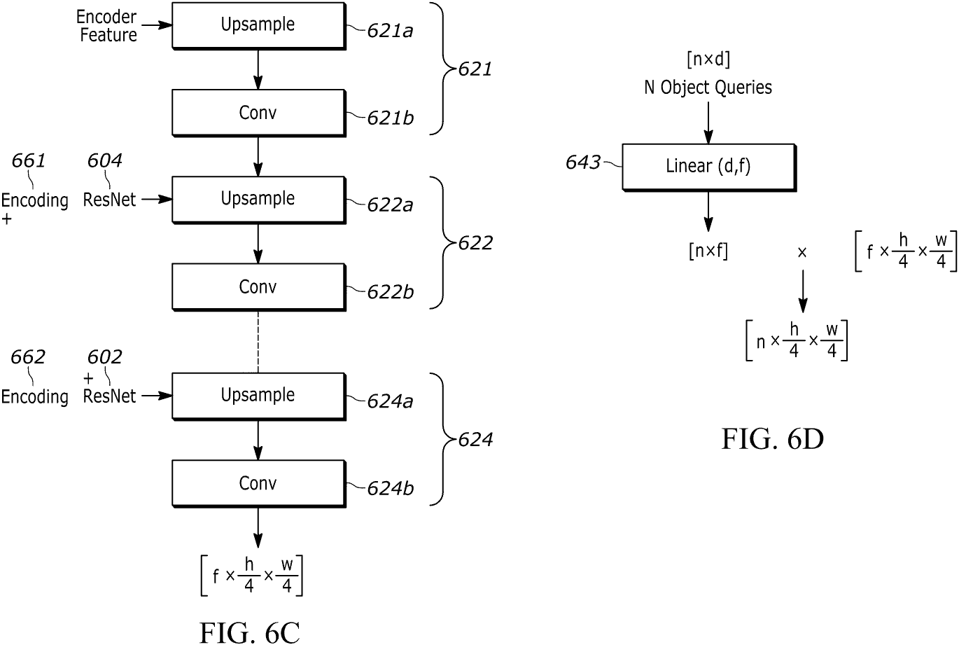

Given an input image I with shape [3, h, w], the feature extractor 510 extracts a set of feature maps (e.g., feature map at level 1, c₄ × h/32 × w/32; feature map at level 2, c₃ × h/16 × w/16; feature map at level 3, c₂ × h/8 × w/8; feature map at level 4, c₁ × h/4 × w/4) with shape [cᵢ, h/ri, w/rᵢ] for cᵢ E [256, 512, 1024, 2048] and rᵢ E [4, 8, 16, 32] with cᵢ representing a number of columns and rᵢ indicating a resolution of an image. In one example, the feature extractor 510 is set to be a residual neural network (ResNet) together with a transformer encoder with self-attention as illustrated in FIG. 6A. In another example, it is also possible to use a vision transformer architecture like the Swin Transformer.

In one example, a final output of the feature extractor 510 has a 1/32 resolution of the image, which is too low for dense prediction tasks like edge detection. Thus, a feature pyramid network 520 is integrated to increase the feature resolution and to fuse the information from the high-level semantic features and low-level finer features. Initially, a 1 × 1 kernel is applied to each stage’s feature maps (e.g., feature map at level 1, c₄ × h/32 × w/32; feature map at level 2, c₃ × h/16 × w/16; feature map at level 3, c₂ × h/8 × w/8; feature map at level 4, c₁ × h/4 × w/4) to project them to f channels (e.g., 256 channels). Then positional encoding 560 is added to the projected features, which will enable the object queries 505 to better localize objects and their boundaries. In each layer of the FPN 520, in one example, the previous layer’s lower resolution feature map is upsampled and fused together with the corresponding higher resolution feature map from the feature extractor 510 using a 3 × 3 convolution, followed by GroupNorm and ReLU non-linearity. In one example, this process is repeated three times; i.e., increasing the feature resolution from 1/16 to ⅛ to ¼ of the image resolution. Nearest neighbor upsampling is used because the nearest neighbor upsampling produces better results compared to bilinear or transpose convolution.

The transformer decoder 530 predicts a class, a box, and edge information for each object instance. Given n input object queries 505 each with d dimensions (i.e., size [n, d]), the transformer decoder 530 first applies self-attention so that the object queries can interact with each other to remove redundant predictions. The transformer decoder 530 then applies cross attention between each object query Q with shape [n, d] and the output M of feature extractor 510:

$$\text{cA} \left(\text{Q,M}\right) = \text{softmax} \left({\text{QM}}^{\text{T}} / \text{square root d}\right) \text{M}$$

Specifically, the model is trained to learn query and key mappings, to project each object query and each image feature (e.g., at each spatial position), respectively. Then for each query, the model computes the dot-product to each key, and normalizes with a softmax, to produce an attention map (A) for the query. The attention map is used to combine the values, which are the projected image features using a learned value mapping, and to update the corresponding object query.

In this way, each query can attend to the image features to obtain information about an object instance’s category, location, and boundary. The decoder design accelerates training by ~6x compared to previous approaches through explicitly separating the spatial and content features of each object query.

The modeling design for edge prediction is motivated by three observations. First, without training with any dense pixel-level labels, and instead, with only box supervision, the cross attention maps computed between the object queries and encoder features have the nature to focus on instance edges. Second, the encoder features within the same object instance have similar representations. Third, by directly taking a weighted combination of the high-resolution feature maps along channel dimension, it leads to mask predictions that can clearly follow the boundaries of the instances. These three observations suggest that convolving the feature maps with each object query will lead to accurate pixel-level instance edge predictions.

Given the transformer decoded object queries Q with shape [n, d], and image features F from the FPN 520 with shape [f, h/4, w/4], this model predicts f weight coefficients for each object query with a simple linear projection:

Q′ = sigmoid(linear(d, f)(Q)) (equation 2)

where linear(i, j) indicates linear projection from dimension i to j. The result is a coefficient for each query; i.e., coefficient tensor with shape [n, f]. This operation corresponds to the coefficient head 543 shown in FIG. 5.

Then, to predict the edge map for each object query, the model applies a 1 × 1 convolution to the feature maps F using the object query Q′ coefficients as filter weights. This is equivalent to apply a batch matrix multiplication between Q′ and F:

$${\text{O}}_{\text{i}} = \text{sigmoid} \left({{\text{Q}}^{′}}_{\text{i}} \times \text{F}\right) , {∀}_{\text{i}}$$

where i is the index of object query, Q′ᵢ has shape [1, f], F has shape [f, h, w], and Oᵢ has shape [h, w]. In one example, all object queries are multiplied with the same set of feature maps. This dense prediction head is general and very light weight, and is applicable to any object instance based pixel classification tasks. For example, this model can obtain mask segmentations by only changing the edge detection loss function to a mask segmentation loss.

FIGS. 6A and 6B illustrate a point supervised transformer model 600 for instance edge detection in accordance with one embodiment. The point supervised transformer model 600 includes similar components in comparison to the model 500 of FIG. 5 with the feature extractor 510 being implemented with ResNet backbone 610, which includes blocks 601-605 and transformer encoder 608. The n object queries 605, FPN 620, transformer decoder 630, prediction head 640, matrix multiplier 650, and positional encoding 660 are similar to the n object queries 505, FPN 520, transformer decoder 530, prediction head 540, batch matrix multiplier 550, and positional encoding 560, respectively, of FIG. 5. The prediction head 640 includes a box head 641, a classification head 642, and a coefficient head 643. The transformer decoder 630 can receive a highest level feature map from the feature extractor while the FPN receives some or all levels of feature maps from the feature extractor.

FIG. 6C illustrates operations of the FPN 620 in accordance with one embodiment. Given an input image I with shape [3, h, w], the backbone 610 and transformer encoder 608 extract a set of feature maps (e.g., feature map at level 1, c₄ × h/32 × w/32; feature map at level 2, c₃ × h/16 × w/16; feature map at level 3, c₂ × h/8 × w/8; feature map at level 4, c₁ × h/4 × w/4) with shape [cᵢ, h/rᵢ, w/rᵢ] for cᵢ E [256, 512, 1024, 2048] and rᵢ E [4, 8, 16, 32] from an input image.

In one example, a final output of the transformer encoder 608 has a 1/32 resolution of the image, which is too low for dense prediction tasks like edge detection. Thus, a feature pyramid network 620 is integrated to increase the feature resolution and to fuse the information from the high-level semantic features and low-level finer features. Each layer 621, 622, 624 of the FPN 620 includes an upsample component 621a, 622a, 624a and convolution 621b, 622b, 624b, respectively.

Initially in one example, a 1 × 1 kernel is applied to each stage’s feature maps (e.g., feature map at level 1, c₄ × h/32 × w/32; feature map at level 2, c₃ × h/16 × w/16; feature map at level 3, c₂ × h/8 × w/8; feature map at level 4, c₁ × h/4 × w/4) to project them to f channels (e.g., 256 channels). Then positional encoding 660 (e.g., positional encoding 661, 662) is added to the projected features, which will enable the object queries 605 to better localize objects and their boundaries. In each layer (e.g., layers 621, 622, 624) of the FPN 620, the previous layer’s lower resolution feature map is upsampled with an upsample component (e.g., 621a, 622a, 624a) and fused together with the corresponding higher resolution feature map from the transformer encoder 608 using a 3 × 3 convolution (e.g., convolution 621b, 622b, 624b), followed by GroupNorm and ReLU non-linearity. In one example, this process is repeated three times; i.e., increasing the feature resolution from 1/16 to ⅛ to ¼ of the image resolution.

FIG. 6D illustrates operations of the coefficient head 643 and matrix multiplier 650 in accordance with one embodiment. Given the transformer decoded object queries Q with shape [n, d], and image features F from the FPN 620 with shape [f, h/4, w/4], this coefficient head 643 predicts f weight coefficients for each object query with a simple linear projection:

$${\text{Q}}^{′} \text{= sigmoid} \left(\text{linear} \left(\text{d, f}\right) \left(\text{Q}\right)\right)$$

where linear(i, j) indicates linear projection from dimension i to j. The output from the head 643 is a coefficient for each query; i.e., coefficient tensor with shape [n, f].

Then, to predict the edge map for each object query, the model applies a 1 × 1 convolution to the feature maps F using the object query Q′ coefficients as filter weights. This is equivalent to apply a matrix multiplication with matrix multiplier 650 between Q′ and F:

$${\text{O}}_{\text{i}} = \text{sigmoid} \left({{\text{Q}}^{′}}_{\text{i}} \times \text{F}\right) , {∀}_{\text{i}}$$

where i is the index of object query, Q′i has shape [1, f], F has shape [f, h, w], and Oi has shape [h, w]. FIG. 6D illustrates one example in which the output [n × f] from head 643 is matrix multiplied with output [f × h/4 × w/4] from the FPN 620 to generate an output [ n × h/4 × w/4] of the matrix multiplier 650.

As dense labeling of all pixels along an object instance’s contour can be extremely expensive, this model trains an instance edge detector using only point supervision along the object’s boundary, similar to how instance segmentation methods are trained with keypoint-based polygon masks. Note that simply connecting adjacent keypoints to ‘complete the edge’ will lead to incorrect annotations that are not on the ground-truth edge as shown in FIG. 3A.

To address this, a novel training objective is designed to account for the sparse keypoint annotation. Specifically, this model includes a penalty-reduced pixel-wise logistic regression with focal loss, which is designed to reduce the penalty in slightly mispredicted corners of a bounding box since those slightly shifted boxes will also localize the object well. In our case, this loss is used to account for slightly mispredicted keypoints. Also a different issue is that a large portion of the ground-truth edges are not annotated at all. To handle the lack of annotations, this model constructs the ground-truth in the following way.

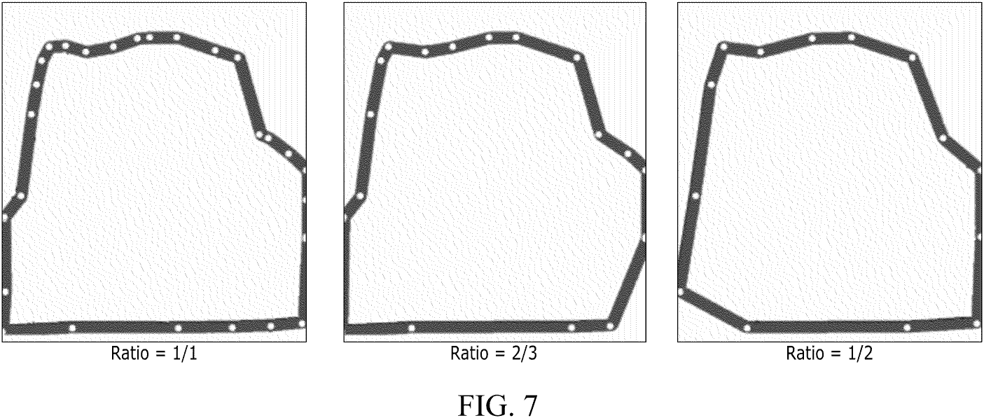

Initially, ground-truth keypoints are connected to create edges, and then blur the result with a small 3 × 3 kernel (e.g., a Gaussian or a box filter). This creates a “tunnel” having values that are greater than 0. In one example, these values are set to 0.3, and the original keypoints as 1, as shown in FIG. 7, which illustrates annotated points as circles that are regarded as positive samples. The tunnels are illustrated with black lines in the regions between the annotated points. The tunnels are located inside penalty reduced regions. The ratios 1/1, ⅔, and ½ indicate different fractions of annotated points with the ratio = 1/1 having more annotated points than the ratio = ⅔, which has more annotated points than the ratio = ½. The lower values for the tunnels account for the uncertainty in ground-truth edge location for the non-keypoints. Alternatively, this model could also take continuous values that degrade as a function of distance to the keypoints and edges. This model uses ground-truth maps Y as targets to the penalty-reduced pixel-wise logistic regression with focal loss:

$$\begin{matrix}{\text{L}}_{\text{k}} = \text{-} 1 / \text{N} {\sum }_{\text{cxy}} \left\{{\left(1 - \hat{} {\text{Y}}_{\text{cxy}}\right)}^{α} log \left(\hat{} {\text{Y}}_{\text{cxy}}\right) {\text{if Y}}_{\text{cxy}} > γ\right) \\ {\left(1 - {\text{Y}}_{\text{cxy}}\right)}^{β} {\left(\hat{} {\text{Y}}_{\text{cxy}}\right)}^{α} log \left(1 - \hat{} {\text{Y}}_{\text{cxy}}\right) \text{else}\end{matrix}$$

where α and β are hyper-parameters of focal loss, and N is the number of annotated keypoints inside an image. In this example, the model sets α = 2 and β = 4, and set _{γ} = 0.3.

^Y_{cxy} and Y_{cxy} denote the prediction and ground truth value at location c, x, y. With this loss, the model is encouraged to accurately predict the annotated edge points, while also predicting edge points inside the ‘tunnels’ that connect those keypoints.

Our final objective combines the following: for edge detection, point supervised loss as well as a sigmoid focal loss is used between the matched prediction and ground truth edge pairs. For bounding box regression, L1 and generalized IoU loss are applied. For classification and to match each object query to a ground truth box, the paired matching loss is used:

$$\hat{} \text{σ} = {\text{arg min}}_{\text{σε} \text{P} \left(\text{N}\right)} {\sum }^{\text{N}} {}_{\text{i}} {\text{L}}_{\text{match}} \left({\text{y}}_{\text{i}} , \hat{} {\text{y}}_{σ \left(\text{i}\right)}\right)$$

where ^y is the corresponding prediction value and y is the ground truth. P (N) denotes the set of permutations of the ground truth and prediction matchings. Finally, to produce instance masks, the model uses the dice loss and sigmoid focal loss.

Next, the datasets and evaluation metrics used for evaluating instance edge detection are explained. The implementation details of the point supervised transformer model are described below.

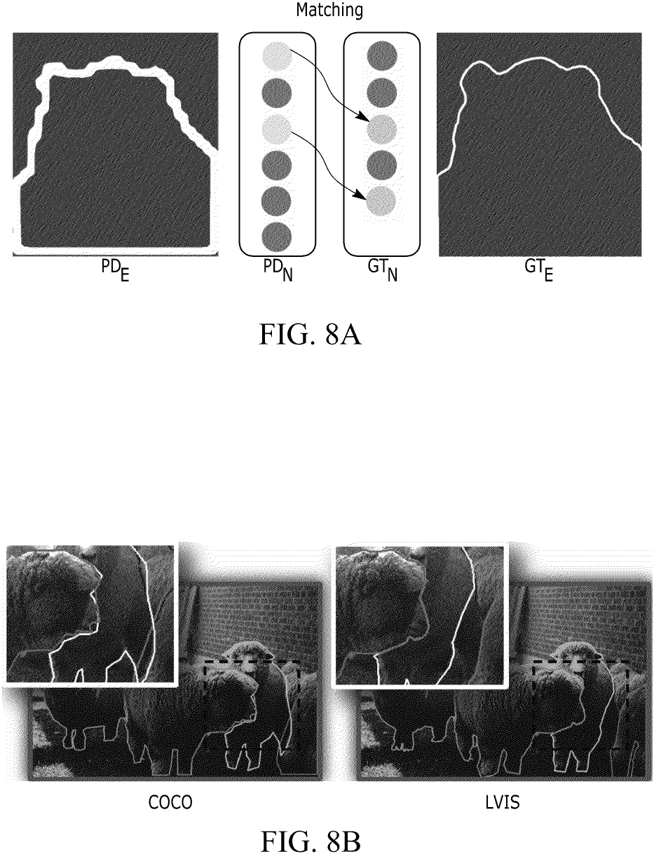

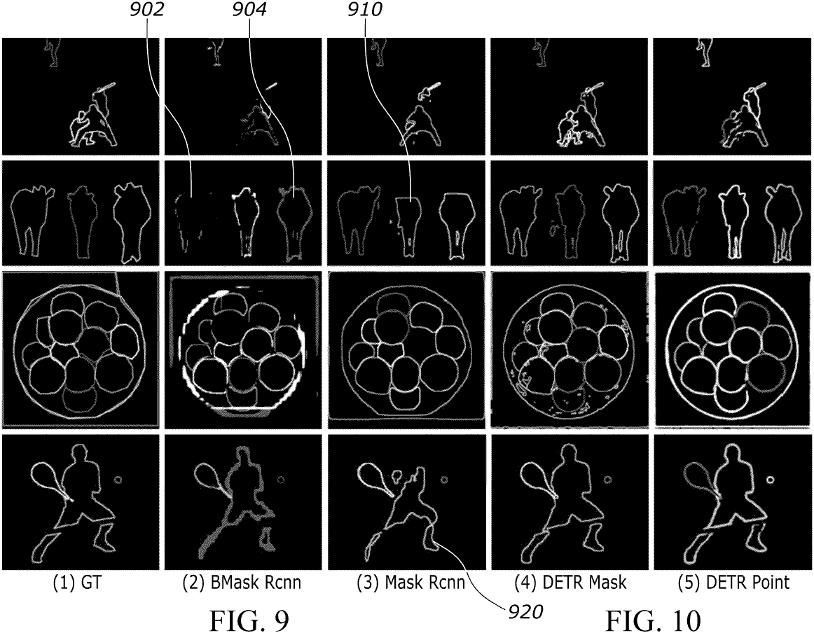

The model is trained on COCO and evaluated on both COCO as well as LVIS as the boundary annotations in LVIS are much more precise, as shown in FIG. 8B. COCO contains 118 K images for training, and 5 K images for evaluation with around 1.5 M object instances. and 80 categories. The annotation contains bounding box, category labels, and keypoint-based mask polygons. All instances in the dataset are exhaustively annotated. Polygons in a feature class are used to mask or cover portions of the feature representation to be hidden from view. Masking is used to clarify maps that are densely packed with annotation and symbology.

LVIS contains 164 K images and 2.2 M high-quality instance segmentation masks for over 1000 entry-level object categories. Its images are a subset of the images from COCO. All the annotated instances that overlap with COCO are kept and relabel the categories in the same way as COCO for evaluation. As well-established problems, both semantic aware and agnostic edge detection have standard evaluation pipelines. The same standard ODS (optimal dataset scale), OIS (optimal image scale), and AP (average precision) metrics are used to evaluate instance edge detection.

Briefly, an edge thinning step is typically applied to produce (near) pixel-wide edges. Then, bipartite matching is used to match the predicted edges PD with the ground-truth edges GT as illustrated in FIG. 8A. Candidate matches have a distance that is within a small pre-defined distance proportional to the image size. Then, precision p and recall r are computed, where precision measures the number of predicted edge points that are matched to a ground truth edge, and recall measures the number of ground truth edge points that are matched to a predicted edge. The F-measure is then computed as 2 • p • r/(p + r). ODS is the best F-measure using the global optimal threshold across the entire validation set. OIS is the aggregate F-measure when the optimal threshold is chosen for each image. AP is the area under the precision/recall curve.

For COCO, all models are trained on GPUs with per GPU batch size of 4. The point supervised edge detection model of the present disclosure is listed as DETR Point and a predicted mask is DETR Mask in Table 1 and then compared to other approaches. For the experiments in Table 1, the resolution of the FPN outputs are ¼ of the original image size. Otherwise, the FPN output features are ⅛ of the image size. Unless specified, the training schedule is 50 epochs. In this example, the AP threshold is set to 20, and a max distance of 0.0075. To evaluate object detection and instance segmentation, a standard cocoapi public is used.

TABLE 1

Edge detection, object detection and instance segmentation results on MSCOCO and LVIS.

| | | | COCO | | | | | LVIS | | |
|---|---|---|---|---|---|---|---|---|---|---|
| | Backbone | Epochs | ODS | OIS | AP^{edge} | AP^{box} | AP^{mask} | ODS | OIS | Ap^{edge} |
| BMask R-CNN | ResNet 50 | 50 | 40.5 | 44.4 | 20.9 | 38.6 | 36.6 | 43.5 | 44.9 | 23.3 |
| Mask R-CNN | ResNet 50 | 50 | 56.7 | 56.7 | 43.4 | 38.6 | 35.2 | 60.0 | 60.3 | 48.4 |
| DETR Mask | ResNet 50 | 50 | 56.3 | 56.4 | 37.1 | 41.1 | 34.5 | 60.3 | 60.7 | 40.9 |
| PointRend | ResNet 50 | 50 | 60.2 | 60.3 | 46.3 | 38.3 | 36.2 | 66.8 | 66.8 | 53.3 |
| DETR Point | ResNet 50 | 50 | 63.4 | 64.2 | 54.0 | 41.3 | - | 67.1 | 68.4 | 59.0 |
| Mask R-CNN | ResNet 50 | 150 | 57.3 | 57.3 | 43.9 | 41.0 | 37.2 | 61.1 | 61.4 | 49.7 |
| DETR Mask | ResNet 50 | 108 | 57.7 | 58.0 | 38.9 | 43.2 | 36.1 | 61.4 | 61.7 | 42.3 |
| PointRend | ResNet 50 | 150 | 61.6 | 61.8 | 47.8 | 41.0 | 38.3 | 65.5 | 65.7 | 51.8 |
| DETR Point | ResNet 50 | 108 | 63.0 | 63.7 | 54.0 | 43.3 | - | 67.5 | 69.0 | 58.6 |
| BMask R-CNN | ResNet 101 | 50 | 41.0 | 44.8 | 21.3 | 40.6 | 38.0 | 49.7 | 52.0 | 21.3 |
| DETR Mask | ResNet 101 | 50 | 57.1 | 57.4 | 38.2 | 42.9 | 35.8 | 61.4 | 61.9 | 42.0 |
| DETR Point | ResNet 101 | 50 | 64.0 | 64.9 | 54.6 | 42.9 | - | 67.6 | 69.2 | 59.7 |
| Mask R-CNN | ResNet 101 | 150 | 58.1 | 58.3 | 45.0 | 42.9 | 38.6 | 62.3 | 62.8 | 51.7 |
| DETR Mask | ResNet 101 | 108 | 58.0 | 58.3 | 39.1 | 44.5 | 37.2 | 62.5 | 62.8 | 43.2 |
| PointRend | ResNet 101 | 150 | 62.4 | 62.4 | 48.5 | 43.5 | 40.1 | 67.9 | 67.9 | 54.6 |
| DETR Point | ResNet 101 | 108 | 64.4 | 65.3 | 54.3 | 44.5 | - | 67.9 | 69.5 | 59.0 |

The only existing approach that predicts edges for instances is boundary preserving Mask R-CNN (BMask R-CNN), which learns a separate edge detection head in parallel with the mask and box heads in Mask R-CNN to generate instance edges.

In addition, since instances edges can be computed from instance segmentation masks, DETR mask is compared to the boundaries of the masks produced by Mask R-CNN. This baseline is used to demonstrate that this way of computing instance edges is insufficient due to the bias in the mask segmentation objective, which rewards accurate prediction of interior pixels in the ground-truth mask more than those that are on the boundary since the boundary pixels are relatively much fewer. The point supervised edge detection model generates instance segmentation masks for Mask R-CNN, and then computes edge boundaries from the masks using a laplacian filter.

For instance segmentation and object detection, the DETR Mask model is compared to both BMask R-CNN and Mask R-CNN.

In Table 1, the point supervised edge detection model (DETR point in Table 1) is compared with various state-of-the-art baselines for the edge detection, object detection, and instance segmentation tasks using the COCO and LVIS datasets.

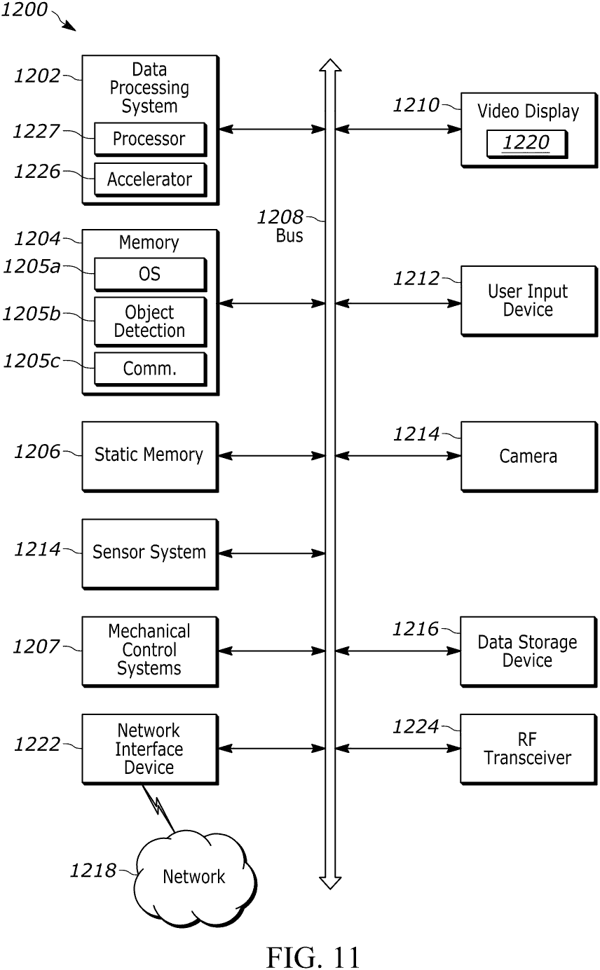

On the COCO dataset, the point supervised edge detection model of the present disclosure achieves the best results under all three edge detection metrics compared to BMask R-CNN and Mask R-CNN. Surprisingly, the point supervised edge detection model achieves ~1.7 times better performance than BMask R-CNN, which is the closest baseline. When taking a closer look at the qualitative results in FIGS. 9 and 10, the reason becomes clear. For example, in the second column of FIG. 9, using the same edge probability threshold, the thickness of the predicted instance boundaries for BMask R-CNN varies widely. This indicate that the BMask R-CNN model lacks a unified treatment for all instances, and thus it is harder to find a single threshold that works well for all instances in all images. The point supervised edge detection model, which is labeled as DETR point in the 2nd column of FIG. 10, does not have similar issues with the thickness of the predicted instance boundaries being uniform. The quantitative results on OIS and ODS in Table 1 again proves this hypothesis: the OIS improves by around 3-4 points for BMask R-CNN while it remains relatively constant for all other models. In addition, because the predicted masks for Mask R-CNN and DETR Mask are directly thresholding to obtain edge detections, their OIS and ODS remain nearly constant under all mask settings.

Apart from the better performance compared to the edge detection method of BMask R-CNN, the point supervised edge detection model also performs better than instance segmentation methods, Mask R-CNN and a mask variant DETR Mask of the present disclosure. This is mainly due to two reasons: (1) The baseline mask predictions are inaccurate along boundaries. (2) The baseline mask can have holes inside. These observations are further described below under qualitative results.

On the LVIS dataset, the results are consistent with those on the COCO dataset. However, in general all methods achieve better results using LVIS annotations. This is also explainable by viewing FIG. 8B due to LVIS having more precise boundary annotations than COCO. The predictions are usually aligned better with these more accurate annotations.

In regards to object detection, the point supervised edge detection model also achieves the best result on AP^{box} with ~2.7 points higher on ResNet 50 with 1x schedule compared with both Mask R-CNN and BMask R-CNN. When training with an extensive schedule, DETR based approaches are still ~2.3 points higher than the baselines on ResNet50. The improvement trend continues to hold when enlarging the backbone to ResNet 101 with ~2.3, ~1.6 points higher on 1x and 2x schedule.

For instance segmentation, the baselines on the instance segmentation task are compared to the DETR mask model of the present disclosure with the dense prediction head plus mask loss. The DETR mask model performs ~2.1 and ~0.7 points worse for AP^{mask} than BMask R-CNN and Mask R-CNN for ResNet 1x schedule models. When training longer, this gap still remains. The major reason is caused by inaccurate predictions on small and medium objects. However, on AP_{L}, the DETR Mask actually performs ~1.9 and ~5.4 points better than Mask R-CNN and BMask R-CNN using ResNet50 1x schedule model.

For an Ablation study, the effect of the point supervised training objective, which models the uncertainty in the edges that are not labeled by the keypoints by assigning them a softer target score, is reviewed. The training objective is compared to BMask R-CNN, which simply connects the keypoints to create ground-truth edges, and applies both a weighted binary cross-entropy loss and the dice loss. As shown in Table 2 below, training with our point supervision objective (point) produces significantly better edge detection performance on both COCO and LVIS datasets compared to the baseline (edge). Furthermore, the improvements on edge detection also lead to a 0.5 improvement in AP^{box} in Table 2), which demonstrates their complementary relationship.

TABLE 2

Varying the type of ground truth training target for edge detection.

| | COCO | | | | LVIS | | |
|---|---|---|---|---|---|---|---|
| | ODS | OIS | AP^{edge} | AP^{box} | ODS | OIS | AP^{edge} |
| edge | 59.0 | 59.3 | 37.5 | 41.0 | 62.5 | 63.1 | 42.3 |
| point | 63.0 | 63.7 | 54.2 | 41.5 | 66.7 | 67.9 | 59.5 |

A key advantage of training an edge detector with point supervision is the large reduction in annotation effort that is required. How the number of annotated edge points affects instance edge detection performance is reviewed. Specifically, the number of end points is sampled that are used for training from 1/1 to ⅔ to ½ of the full original set of annotated keypoints. As shown in Table 3, by decreasing the annotation by ⅓ and ½, both ODS and OIS decreases as expected but not by a large amount. The reduction in AP is larger.

TABLE 3

Varying the number of ground truth edge points used for training.

| | COCO | | | | LVIS | | |
|---|---|---|---|---|---|---|---|
| ratio | ODS | OIS | AP^{edge} | AP^{box} | ODS | OIS | AP^{edge} |
| ½ | 58.4 | 59.4 | 32.4 | 41.3 | 61.7 | 63.9 | 31.0 |
| ⅔ | 61.7 | 62.5 | 48.9 | 41.1 | 64.7 | 66.4 | 34.5 |
| 1/1 | 63.0 | 63.7 | 54.2 | 41.5 | 66.7 | 67.9 | 59.5 |

With fewer keypoints, the model’s overall prediction scores decrease in magnitude, and this has a larger effect on AP, which integrates over all precision values unlike ODS and OIS that choose the single best F-measure over all decision thresholds.

For annotation types, the DETR based dense prediction framework is ablated under different types of annotations (e.g., box, mask, and edge). As shown in Table 4, simply adding mask annotations will not improve bounding box performance.

TABLE 4

Varying annotation types (bounding boxes, masks, and edges) for model training.
COCO

| box mask edge | AP^{box} | Ap^{mask} | ODS | OIS | AP^{edge} |
|---|---|---|---|---|---|
| | 40.9 | - | - | - | - |
| | 40.9 | 33.3 | 54.5 | 54.7 | 35.4 |
| | 41.5 | - | 63.0 | 63.7 | 54.2 |
| | 41.4 | 33.9 | 63.0 | 63.7 | 54.0 |

However, by adding edge annotations, box prediction improves by ~0.6 points. Compared with training only on instance segmentation, simultaneously training edge detection and instance segmentation improves mask AP^{box} by ~0.6 point whereas the edge detection results remain similar.

For a fair comparison, all qualitative results are using the models that are trained with a ResNet 50 backbone with 1x schedule. We threshold the mask probability with 0.5 to obtain the binary mask together with their boundaries. For edge detection methods, 0.7 is used as a threshold to filter out noisy predictions. As mentioned above, clear reasons are observed for why the point supervised instance edge detection model achieves better performance for edge detection. For example, in the second row of FIG. 9, while the blue cow 902 predicted by BMask R-CNN is nearly thresholded out, the edge of the yellow cow 904 remains very thick. This is the primary reason for BMask R-CNN′s low performance. Further, the third column of FIG. 9 shows the results of Mask R-CNN, which clearly indicate that it is usually unable to predict the boundaries well (e.g., the blue cow 910 in second row, the person 920 in fourth row) compared with the DETR Mask and DETR Point of the present disclosure. Although DETR Mask usually generates high quality boundaries, when the mask is large, redundant predictions or holes can appear in the mask as shown in the fourth column.

In conclusion, a novel point supervised transformer model for edge detection is disclosed. A dense prediction head is added to the DETR framework, and shows that this prediction head can easily be applied to both instance segmentation and edge detection.

FIG. 11 is a diagram of a computer system including a data processing system that utilizes a processing logic according to an embodiment of the invention. Within the computer system 1200 is a set of instructions for causing the machine to perform any one or more of the methodologies discussed herein including accelerating machine learning operations (e.g., methods for instance edge detection and instance segmentation). In alternative embodiments, the machine may be connected (e.g., networked) to other machines in a LAN, an intranet, an extranet, or the Internet. The machine can operate in the capacity of a server or a client in a client-server network environment, or as a peer machine in a peer-to-peer (or distributed) network environment, the machine can also operate in the capacity of a web appliance, a server, a network router, switch or bridge, event producer, distributed node, centralized system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

Data processing system 1202, as disclosed above, includes processing logic in the form of a general purpose instruction-based processor 1227 or an accelerator 1226 (e.g., graphics processing units (GPUs), FPGA, ASIC, etc.)). The general purpose instruction-based processor may be one or more general purpose instruction-based processors or processing devices (e.g., microprocessor, central processing unit, or the like). More particularly, data processing system 1202 may be a complex instruction set computing (CISC) microprocessor, reduced instruction set computing (RISC) microprocessor, very long instruction word (VLIW) microprocessor, general purpose instruction-based processor implementing other instruction sets, or general purpose instruction-based processors implementing a combination of instruction sets. The accelerator may be one or more special-purpose processing devices such as an application specific integrated circuit (ASIC), a field programmable gate array (FPGA), a digital signal general purpose instruction-based processor (DSP), network general purpose instruction-based processor, many light-weight cores (MLWC) or the like. Data processing system 1202 is configured to implement the data processing system for performing the operations and steps discussed herein. The exemplary computer system 1200 includes a data processing system 1202, a main memory 1204 (e.g., read-only memory (ROM), flash memory, dynamic random access memory (DRAM) such as synchronous DRAM (SDRAM) or DRAM (RDRAM), etc.), a static memory 1206 (e.g., flash memory, static random access memory (SRAM), etc.), and a data storage device 1216 (e.g., a secondary memory unit in the form of a drive unit, which may include fixed or removable non-transitory computer-readable storage medium), which communicate with each other via a bus 1208. The storage units disclosed in computer system 1200 may be configured to implement the data storing mechanisms for performing the operations and steps discussed herein. Memory 1206 can store code and/or data for use by processor 1227 or accelerator 1226. Memory 1206 include a memory hierarchy that can be implemented using any combination of RAM (e.g., SRAM, DRAM, DDRAM), ROM, FLASH, magnetic and/or optical storage devices. Memory may also include a transmission medium for carrying information-bearing signals indicative of computer instructions or data (with or without a carrier wave upon which the signals are modulated).

Processor 1227 and accelerator 1226 execute various software components stored in memory 1204 to perform various functions for system 1200. Furthermore, memory 1206 may store additional modules and data structures not described above.

Operating system 1205a includes various procedures, sets of instructions, software components and/or drivers for controlling and managing general system tasks and facilitates communication between various hardware and software components. Algorithms 1205b (e.g., method 300, point supervised instance edge detection and instance segmentation algorithms, etc.) utilize sensor data from the sensor system 1214 for object detection and segmentation for different applications such as autonomous vehicles or robotics. A communication module 1205c provides communication with other devices utilizing the network interface device 1222 or RF transceiver 1224.

The computer system 1200 may further include a network interface device 1222. In an alternative embodiment, the data processing system disclose is integrated into the network interface device 1222 as disclosed herein. The computer system 1200 also may include a video display unit 1210 (e.g., a liquid crystal display (LCD), LED, or a cathode ray tube (CRT)) connected to the computer system through a graphics port and graphics chipset, an input device 1212 (e.g., a keyboard, a mouse), and a Graphic User Interface (GUI) 1220 (e.g., a touch-screen with input & output functionality) that is provided by the display unit 1210.

The computer system 1200 may further include a RF transceiver 1224 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/de-interleaving, spreading/dispreading, inverse fast Fourier transforming (IFFT)/fast Fourier transforming (FFT), cyclic prefix appending/removal, and other signal processing functions.

The Data Storage Device 1216 may include a machine-readable storage medium (or more specifically a computer-readable storage medium) on which is stored one or more sets of instructions embodying any one or more of the methodologies or functions described herein. Disclosed data storing mechanism may be implemented, completely or at least partially, within the main memory 1204 and/or within the data processing system 1202 by the computer system 1200, the main memory 1204 and the data processing system 1202 also constituting machine-readable storage media.

In one example, the computer system 1200 is an autonomous vehicle that may be connected (e.g., networked) to other machines or other autonomous vehicles in a LAN, WAN, or any network 1218. The autonomous vehicle can be a distributed system that includes many computers networked within the vehicle. The autonomous vehicle can transmit communications (e.g., across the Internet, any wireless communication) to indicate current conditions (e.g., an alarm collision condition indicates close proximity to another vehicle or object, a collision condition indicates that a collision has occurred with another vehicle or object, etc.). The autonomous vehicle can operate in the capacity of a server or a client in a client-server network environment, or as a peer machine in a peer-to-peer (or distributed) network environment. The storage units disclosed in computer system 1200 may be configured to implement data storing mechanisms for performing the operations of autonomous vehicles.

In one example, as the autonomous vehicle travels within an environment, the autonomous vehicle can employ one or more computer-implemented object detection and segmentation algorithms as described herein to detect objects within the environment. At a given time, the object detection algorithm can be utilized by the autonomous vehicle to detect a type of an object at a particular location in the environment. For instance, an object detection algorithm can be utilized by the autonomous vehicle to detect that a first object is at a first location in the environment (where the first vehicle is located) and can identify the first object as a car. The object detection algorithm can further be utilized by the autonomous vehicle to detect that a second object is at a second location in the environment (where the second vehicle is located) and can identify the second object as a car. Moreover, the object detection algorithm can be utilized by the autonomous vehicle to detect that a third object is at a third location in the environment (where a pedestrian is located) and can identify the third object as a pedestrian. The algorithm can be utilized by the autonomous vehicle to detect that a fourth object is at a fourth location in the environment (where vegetation is located) and can identify the fourth object as vegetation.

The computer system 1200 also includes sensor system 1214 and mechanical control systems 1207 (e.g., motors, driving wheel control, brake control, throttle control, etc.). The processing system 1202 executes software instructions to perform different features and functionality (e.g., driving decisions) and provide a graphical user interface 1220 for an occupant of the vehicle. The processing system 1202 performs the different features and functionality for autonomous operation of the vehicle based at least partially on receiving input from the sensor system 1214 that includes lidar sensors, cameras, radar, GPS, and additional sensors. The processing system 1202 may be an electronic control unit for the vehicle.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A computer implemented method of object instance detection, the computer implemented method comprising:
obtaining an input image with a shape;
extracting, with a feature extractor of a point supervised transformer model, a hierarchical combination of features from the input image including a set of feature maps having different levels;
receiving, with a transformer decoder of the point supervised transformer model, an output including a feature map from the feature extractor, and object queries each with d dimensions;
training the point supervised transformer model with a sparse set of keypoint annotations along a boundary of each object instance; and
generating, with a prediction head, a box prediction, a classification prediction, and a coefficient prediction for each object instance based on an output from the transformer decoder.

2. The computer implemented method of claim 1, wherein the object instance detection comprises object instance edge detection to correctly predict boundaries of each object instance together with its category label with a plurality of object instances within the input image.

3. The computer implemented method of claim 1, further comprising:
fusing, with a feature pyramid network (FPN), the set of feature maps of different levels to increase a feature resolution and to fuse information from high-level semantic features and low-level features.

4. The computer implemented method of claim 1, further comprising:
applying, with the transformer decoder, self-attention so that the object queries interact with each other to remove redundant predictions; and
applying, with the transformer decoder, cross attention between each object query and the output from the feature extractor.

5. The computer implemented method of claim 4, wherein each object query attends to image features F to obtain information about an object instance’s category, location, and boundary.

6. The computer implemented method of claim 1, wherein given the transformer decoded object queries with shape [n, d], and image features F, a coefficient head predicts f weight coefficients for each object query with a simple linear projection from dimension i to j.

7. The computer implemented method of claim 6, further comprising:
applying a convolution to the set of feature maps using object query coefficients as filter weights to predict an edge map for each object query.

8. The computer implemented method of claim 1, further comprising:
providing a loss function to compensate for the sparse set of keypoint annotations along a boundary of each object instance.

9. The computer implemented method of claim 8, wherein boundary regions between the keypoints are assigned a lower value than keypoints to account for uncertainty in ground-truth edge location for non-keypoints.

10. A system for object instance edge detection, the system comprising:
a memory storing instructions; and
a processor coupled to the memory, the processor is configured to execute the instructions to:
obtain an input image with a shape;
extract a hierarchical combination of features from the input image including a set of feature maps having different levels;
receive an output including a feature map, and object queries each with d dimensions;
train a point supervised transformer model with a sparse set of keypoint annotations along a boundary of each object instance; and
provide a loss function to compensate for the sparse set of keypoint annotations along a boundary of each object instance.

11. The system of claim 10, wherein boundary regions between the keypoints are assigned a lower value than keypoints to account for uncertainty in ground-truth edge location for non-keypoints.

12. The system of claim 10, wherein the loss function comprises a penalty-reduced pixel-wise logistic regression with focal loss.

13. The system of claim 10, wherein the processor is further configured to execute the instructions to:
generate a box prediction, a classification prediction, and a coefficient prediction for each object instance based on an output from a transformer decoder.

14. The system of claim 10, wherein the processor is further configured to execute the instructions to:
fuse the set of feature maps of different levels to increase a feature resolution and to fuse information from high-level semantic features and low-level features.

15. The system of claim 10, wherein the processor is further configured to execute the instructions to:
given the transformer decoded object queries with shape [n, d], and image features F, to predict f weight coefficients for each object query with a simple linear projection from dimension i to j.

16. A non-transitory computer readable storage medium having embodied thereon a program, wherein the program is executable by a processor to perform a method of object instance detection, the method comprising:
obtaining an input image with a shape;
extracting, with a feature extractor of a point supervised transformer model, a hierarchical combination of features from the input image including a set of feature maps having different levels;
receiving, with a transformer decoder of the point supervised transformer model, an output including a feature map from the feature extractor, and object queries each with d dimensions;
training the point supervised transformer model with a sparse set of keypoint annotations along a boundary of each object instance; and
generating a box prediction, a classification prediction, and a coefficient prediction for each object instance based on an output from the transformer decoder.

17. The non-transitory computer readable storage medium of claim 16, wherein the object instance detection comprises object instance edge detection to correctly predict boundaries of each object instance together with its category label with a plurality of object instances within the input image.

18. The non-transitory computer readable storage medium of claim 16, the method further comprising:
fusing, with a feature pyramid network (FPN), the set of feature maps of different levels to increase a feature resolution and to fuse information from high-level semantic features and low-level finer features.

19. The non-transitory computer readable storage medium of claim 16, further comprising:
applying, with the transformer decoder, self-attention so that the object queries interact with each other to remove redundant predictions; and
applying, with the transformer decoder, cross attention between each object query and the output from the feature extractor.

20. The non-transitory computer readable storage medium of claim 16, further comprising:
given the transformer decoded object queries with shape [n, d], and image features F, predicting f weight coefficients for each object query with a simple linear projection from dimension i to j.
